(19) United States
(12) Patent Application Publication
(10) Pub. No.: US 2008/0240717 A1
(43) Pub. Date: Oct. 2, 2008

(54) Optical transmitter/receiver module

(75) Inventors: Hirotomo Izumi, Kawasaki (JP); Shigeichi Izumi, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/896,438

(22) Filed: Aug. 31, 2007

(30) Foreign Application Priority Data
Mar. 29, 2007 (JP) 2007-88804

(51) Int. Cl. H04J 14/02

(52) U.S. Cl. 398/79

(57) ABSTRACT

Efficient absorption of radio wave emission can be ensured from a high frequency signal processing circuit in an optical transmitter/receiver module. The optical transmitter/receiver module pluggable to a communication device includes a housing having openings on an anterior and a posterior ends; an optical connector disposed at the anterior opening; a photoelectric converting unit that converts a wavelength-division multiplexed optical signal, that is input from an optical transmission line connected to the optical connector, into an electric signal; and a high frequency circuit board that performs high frequency signal processing of an electric signal converted by the photoelectric converting unit, whereinat the posterior opening, a connecting terminal of the high frequency circuit board is formed so that it is pluggable to a mother board of a communication device, and wherein radio wave absorbers are arranged in spaces between the top/bottom surfaces of the high frequency circuit board and the housing.

### CROSS-REFERENCE TO RELATED APPLICATIONS

This application is based upon and claims the benefit of priority from the prior Japanese Patent Application No. 2007-088804, filed on Mar. 29, 2007, the entire contents of which are incorporated herein by reference.

### BACKGROUND OF THE INVENTION

1. Field of the Invention

The present invention relates generally to an optical transmitter/receiver module, and, more particularly, to an optical transmitter/receiver module that is applicable and pluggable to an optical transmitter/receiver in high speed optical networks such as metro-access networks.

2. Description of the Related Art

In recent years, broad-band leased line services using Gigabit or ten-Gigabit Ethernet for enterprise networks are getting started. On the other hand, high speed Internet environment such as ADSL or FTTH for home use is also improving, and the volume of data to be transferred is rapidly increasing in metro networks.

As a technology for increasing the transmission capacity of the metro networks, there is Wavelength-Division Multiplexing (WDM) that transmits multiplexed optical signals in different wavelengths through a single optical fiber. In WDM transmission system, transmission capacity can be increased proportionally to the number of wavelengths, and while it has mainly been introduced to interurban trunk line networks, it also started to be introduced to optical metro-access systems in recent years.

FIG. 1 is an explanatory view of an exemplary configuration of the optical metro-access network system.

In optical metro-access network system 100, plural photonic gateways (#1 to #m) are arranged on a circular optical transmission line 101, and each photonic gateway (#1 to #m) has a function to insert/split optical signals.

In the example shown in FIG. 1, an optical signal that contains plural optical wavelengths of λ1 to λn, that are wavelength-multiplexed, is transmitted on the optical transmission line 101. Then, an optical signal of wavelength λi is inserted from a photonic gateway #1 and splitted at a photonic gateway #3. Also, a state that an optical signal of wavelength λj is inserted from a photonic gateway #(m-1) and splitted at a photonic gateway #m is shown.

As representatively shown for the photonic gateway #1, each photonic gateway (#1 to #m) is connected to client terminals 103A to 103C of enterprises and/or home users via Gigabit or ten-Gigabit Ethernet 102.

FIG. 2 is a block diagram illustrating an example of the configuration of an optical transmitter/receiver module 1 that is a central functional unit of photonic gateways (#1 to #m).

A wavelength-multiplexed optical signal entered from the optical transmission line 101 is splitted by a splitting unit 10 for a separator 12A and for passing through. The wavelength-multiplexed optical signal that is splitted at the splitter 10 is separated into each wavelength by the separator 12A, and subsequently, an optical signal of a wavelength corresponding with a selected wavelength set at a wavelength tunable filter 12 is extracted, sent to a receiver Rx, and processed after converted into an electric signal.

On the other hand, a signal generated by a transmitter Tx is converted into an optical signal by an electrical-optical converting unit 13, multiplexed with signals of passing wavelengths at a multiplexing unit 11, and transmitted to the optical transmission line 101.

In such an optical metro-access network system as the above, a small-sized and low-cost de fact standard optical transmitter/receiver module with a capacity of ten-Gigabit/s is under development in response to further speeding up. In such the situation, by sharing external feature/fixing method/specification, various transmission service vendors can use optical transmitter/receiver modules with a common configuration, and hence risk at users in the aspects of supply/cost can be averted.

Based on such the concept, MSA (Multi-Source Agreement) standard was established, and among modules satisfying the standard, XFP (ten Gigabit Small Form-factor Pluggable Transceiver) module, i.e., a small-sized optical transmitter/receiver module that is pluggable to a communication device supporting ten-Gigabit is propagating and improving.

In order to mount many modules on a single communication device, recently, modules tend to be mounted in a position where a common line is directly connected (e.g., front face of a communication device) not only by minimizing modules but also by making them pluggable so as to be ready to support the expansion of lines.

For such a reason above, the communication device needs to satisfy the required conditions such as EMI (Electromagnetic Interference), ESD (Electrostatic Discharge), etc. Therefore, optical transmitter/receiver modules to be disposed into the communication device also need to satisfy EMI and ESD standards.

In order to satisfy the conditions of EMI, ESD, etc., a configuration to block out unnecessary radio emission is proposed.

For example, in the invention described in Japanese Patent Application Laid-Open Publication No. 9-270592, in order to block out unnecessary signal (radio wave) from a local oscillator on an LNB board in a transmitter/receiver for the signal reception of satellite broadcasting, etc., it is proposed to dispose a radio wave absorber in the vicinity of the local oscillator, and to substitute plastic resin for die-cast aluminum or the like as material for an LNB cover.

The invention described in Japanese Patent Application Laid-Open Publication No. 2005-50974 pertains to a semiconductor package with fewer false operations, and presents a configuration that an optical receiver module is fixed indirectly to a sealed container with an intermediate radio wave absorber.

Electromagnetic wave emission is generated by the temporal variation of an electromagnetic wave source. Therefore, since the temporal variation of the electromagnetic wave source is intensified if high frequency signal is transmitted, electromagnetic wave emission is also intensified. Thus it is predicted that electromagnetic wave emission is intensified in high speed transmission at ten-Gigabit/s.

FIG. 3 is a cross-sectional side view of an optical transmitter/receiver module 1 as an example. FIG. 4 explains functions corresponding to FIG. 3.

An optical cable (not shown) is inserted to an anterior opening portion 20 in the direction of an arrow A and linked with optical connectors 21 (22). The optical connectors 21 (22) are arranged on the input and output sides of a wavelength-division multiplexed optical signal, respectively, as shown later in its plan view.

The optical transmitter/receiver module 1 contains a converter module 23 that includes a splitting unit 10, a multiplexing unit 11, a separator 12A, a wavelength tunable filter 12, and a photoelectric/electrical-optical converting unit 13.

A low frequency circuit board 31 mounted with a low frequency processing circuit and a high frequency circuit board 32 mounted with a high frequency processing circuit are equipped. The high frequency circuit board 32 is connected to the converter module 23, and connected to a motherboard 4 of the communication device being inserted from the side where plural electrode terminals 33 are formed into the communication device.

In the optical transmitter/receiver module 1 of the above configuration, in the case that high frequency signal processing, e.g., at ten-Gigabit/s, is performed by the high frequency processing circuit mounted on the high frequency circuit board 32, electromagnetic wave emission is intensified, generating noise as described earlier. Specifically, the electromagnetic emission spreads mainly from a posterior opening 30 of the housing of the optical transmitter/receiver module 1 by diffraction effect, and emitted from the anterior opening 20 of the apparatus through a space 24 between the module and a housing 34 where the module is disposed.

### SUMMARY OF THE INVENTION

The object of the present invention is therefore to provide a configuration of an optical transmitter/receiver module, that can adequately reduce the electromagnetic wave emission.

In order to achieve the above object, according to a first aspect of the present invention there is provided an optical transmitter/receiver module pluggable to a communication device, comprising a housing having openings on an anterior and a posterior ends; an optical connector disposed at the anterior opening; a photoelectric converting unit that converts a wavelength-division multiplexed optical signal, that is input from an optical transmission line connected to the optical connector, into an electric signal; and a high frequency circuit board that performs high frequency signal processing of an electric signal converted by the photoelectric converting unit, wherein at the posterior opening, a connecting terminal of the high frequency circuit board is formed so that it is pluggable to a mother board of a communication device, and wherein radio wave absorbers are arranged in spaces between the top/bottom surfaces of the high frequency circuit board and the housing.

The above configuration presents an optical transmitter/receiver module that can adequately reduce electromagnetic wave emission.

To achieve the above object, according to a second aspect of the present invention there is provided an optical transmitter/receiver module connected to the optical transmission line for splitting/insertion of a wavelength-division multiplexed optical signal, the module pluggable to a communication device and comprising a housing having openings on an anterior and a posterior ends; a pair of optical connectors disposed at the anterior opening; a photoelectric converting unit that converts a wavelength-division multiplexed optical signal, that is input from an optical transmission line to one of the pair of optical connectors, into an electric signal; an electrical-optical converting unit that converts the electric signal into an optical signal that is to be output to the other of the pair of connectors and to be transmitted to the optical transmission line; and a high frequency circuit board connected to the photoelectric and the electrical-optical converting units, the high frequency circuit board performing high frequency signal processing, wherein at the posterior opening, a connecting terminal of the high frequency circuit board is formed so that it is pluggable to a mother board of a communication device, and wherein radio wave absorbers are arranged in spaces between the top/bottom surfaces of the high frequency circuit board and the housing.

The radiowave absorber may be magnetic-permeable. This ensures efficient absorption of radio wave emission from a high frequency signal processing circuit.

### BRIEF DESCRIPTION OF THE DRAWINGS

FIG. 1 illustrates an example of the configuration of an optical metro-access network system;

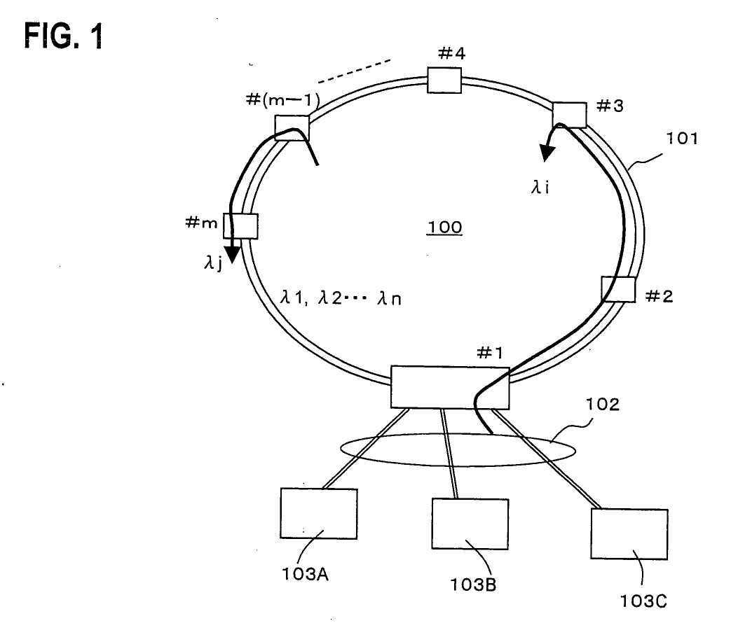

FIG. 2 is a block diagram of an example of the configuration of an optical transmitter/receiver module 1 that is a central functional unit of photonic gateways (#1 to #m);

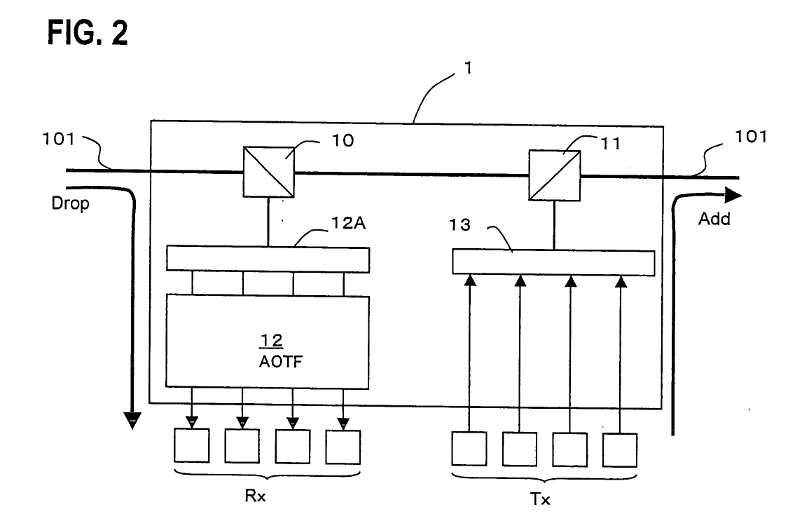

FIG. 3 is a cross-sectional side view of an optical transmitter/receiver module 1 as an example;

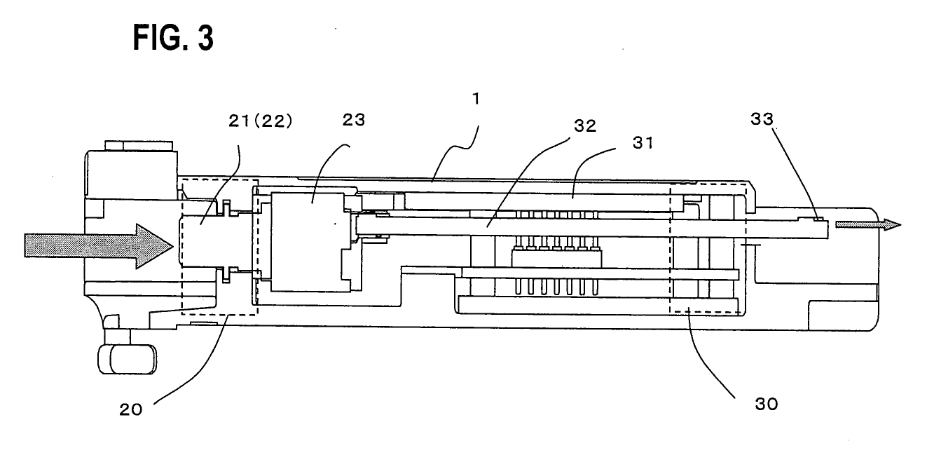

FIG. 4 illustrates functions corresponding to FIG. 3;

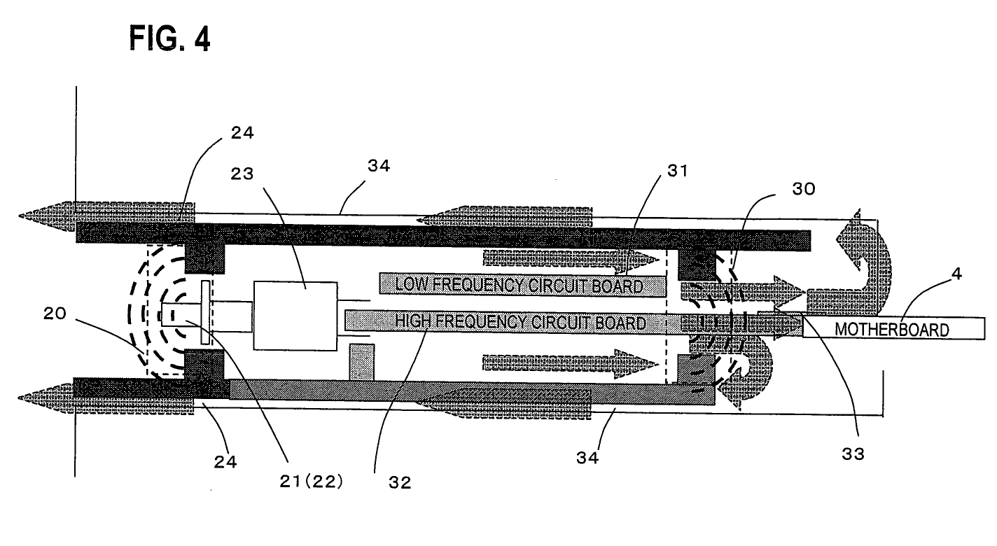

FIG. 5A and 5B are a plan view of an optical transmitter/receiver module 1 of the embodiment of the present invention, and a cross-sectional view taken along line A of FIG. 5A, respectively;

FIGS. 6A and 6B are explanatory views of a type that the generation of electromagnetic wave originates from electric field (E), and a type that the generation of electromagnetic wave originates from magnetic field (H), respectively;

FIGS. 7A and 7B are a table comparing radio wave emission noises that indicate the effectiveness of radio wave absorbers in three types (1 to 3) of arrangements, and a graph of the measurement values shown in FIG. 7A;

FIGS. 8A and 8B are a top view and a bottom view, respectively, of type 1 arrangement of radio wave absorbers;

FIGS. 9A and 9B are a top view and a bottom view, respectively, of type 2 arrangement of radio wave absorbers;

FIGS. 10A and 10B are a top view and a bottom view, respectively, of type 3 arrangement of radio wave absorbers;

FIG. 11 is a schematic cross-sectional view.

### DETAILED DESCRIPTION OF THE PREFERRED EMBODIMENTS

An embodiment of the present invention will now be described with reference to the accompanying drawings.

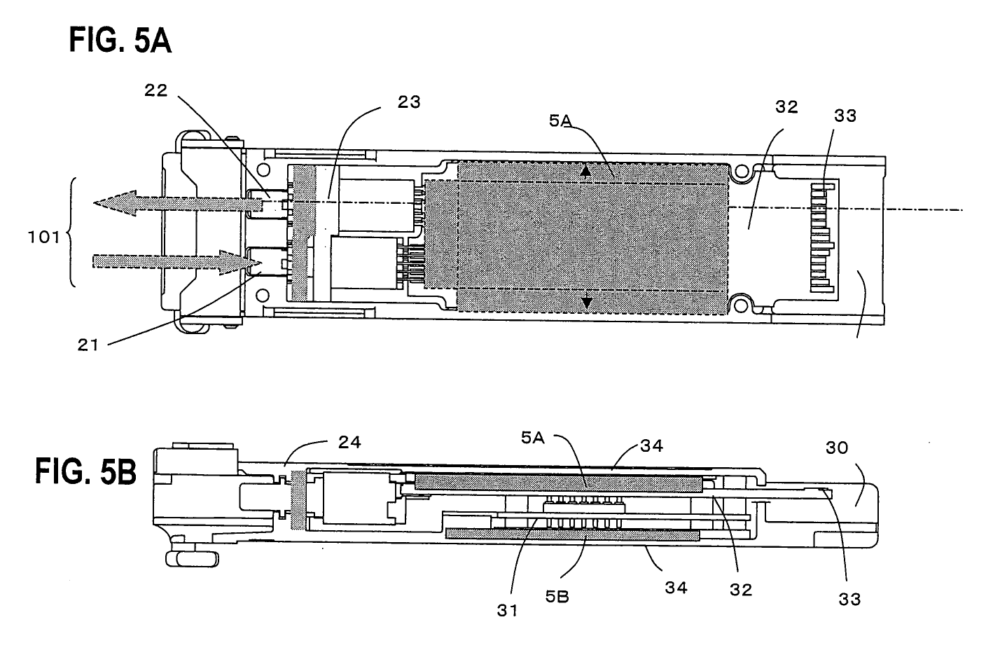

FIG. 5A is a plan view of an optical transmitter/receiver module 1 of the embodiment of the present invention, and FIG. 5B is a cross-sectional view along line A of FIG. 5A.

A housing 34 of the optical transmitter/receiver module 1 has openings 20 and 30 at an anterior and a posterior ends, respectively.

A pair of connectors 21 and 22 are disposed at the anterior opening 20. An optical transmission line 101 is connected to the connector 21, and a wavelength-division multiplexed optical signal is input thereto. On the other hand, a wavelength-division multiplexed optical signal is transmitted from the connector 22 to the optical transmission line 101.

A converting unit 23 is composed of a photoelectric converting unit that converts a wavelength-division multiplexed optical signal, that is input from the optical transmission line 101 to the connector 21 of the pair of connectors, into an electric signal, and an electrical-optical converting unit that converts an electric signal into an optical signal to be output to the other connector 22 of the pair of connectors and then transmitted to the optical transmission line 101.

A high frequency circuit board 32 that is connected to the converting unit 23 mounted with the photoelectric and electrical-optical converting units, and that performs high frequency signal processing is equipped.

At the posterior opening 30, a connecting terminal 33 of the high frequency circuit board 32 is formed so that it is pluggable to a motherboard of a communication device.

As a further characteristic, radio wave absorbers 5A and 5B are arranged between the both upper and lower surfaces of the high frequency circuit board 32 and the housing 34:

In other words, for an application of FIGS. 5A and 5B, the radio wave absorbers 5A and 5B, that absorb radiation noise emitted by the high frequency circuit board 32, are arranged so as to occupy upper and lower spaces 24 in the housing 34. It is important to fill up the spaces 24.

The radio wave absorbers 5A and 5B to be employed here are selected taking the following points into account.

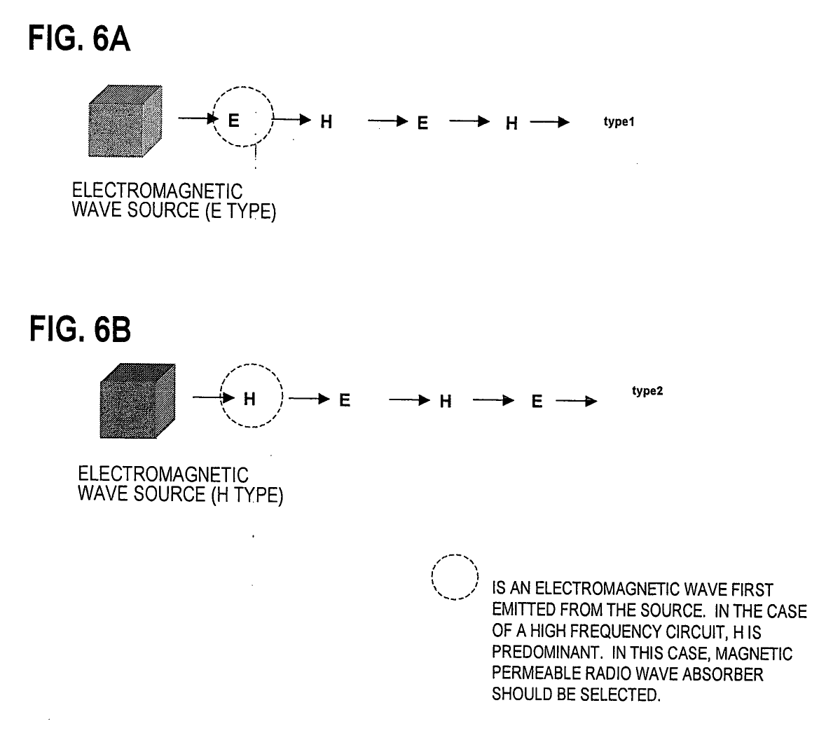

FIGS. 6A and 6B are schematics to explain the generation of electromagnetic wave. Both an electric and a magnetic fields become a source. Electromagnetic wave propagates by the in-turn repetition of generation like electric field→magnetic field→electric field→magnetic field→ . . . .

The selection of the radio wave absorber depends upon if the generation of radio wave starts from a magnetic field or an electric field. FIGS. 6A and 6B show types of radio wave generation that starts from an electric field (E) and that starts from a magnetic field (H), respectively. For a high frequency circuit, electromagnetic wave can efficiently be converted into heat by handling a source as a magnetic field.

Therefore, it is preferable to use magnetic-permeable radio wave absorber for the radio wave absorbers 5A and 5B. The radio wave absorbers 5A and 5B are to convert magnetic energy P_{μ}, that is calculated by the following equation using magnetic permeability μ₀ and relative permeability μ″, into heat.

P_{μ}=(½)ω μ₀ μ″ |H|² (1)

As shown by the equation (1), it is preferable to select a radio absorber with larger μ″. In practice, however, for the case of high frequencies of gigahertz order, radio wave absorber with desirable μ″ hardly exists. Since the radio wave absorber is for converting electromagnetic energy into heat, it is also preferable to select one that is able to highly accumulate heat (heat capacity) and to efficiently release the accumulated heat (thermal conductivity).

However, as it is difficult to produce a radio wave absorber with any substance satisfying all these conditions, a countermeasure to EMI should be taken by improving the arrangement of an available radio wave absorber.

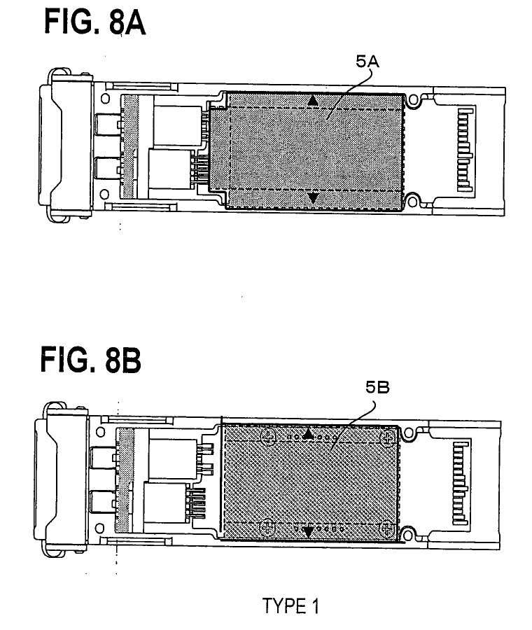

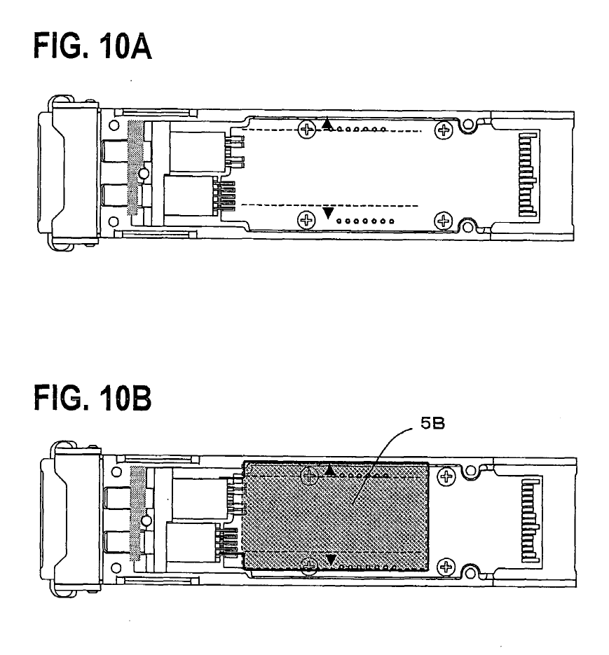

FIGS. 8A and 8B through to FIGS. 10A and 10B are the examined layout patterns of radio absorber. Radio absorbers 5A and 5B are disposed on the sides of the high frequency circuit board 32 and of the low frequency circuit board 31, respectively. It is obvious that electromagnetic wave emission from a high frequency side is dominant according to the generating mechanism of electromagnetic wave. Therefore, with an arrangement, as shown in FIGS. 10A and 10B, where a radio wave absorber is not disposed on the side of the high frequency circuit board 32 adjacent to a major electromagnetic wave source, but is disposed only on the side of the low frequency circuit board 31, effectiveness of such a countermeasure to EMI can not be expected.

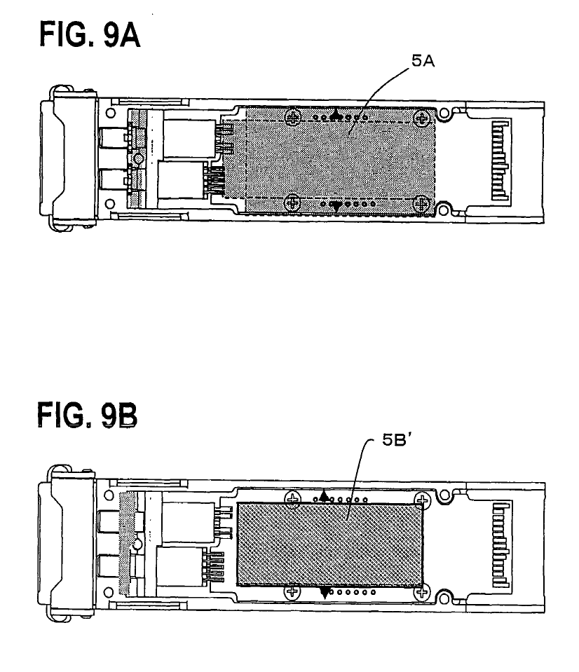

FIGS. 8A and 8B are different from FIGS. 9A and 9B in the layout of a electromagnetic wave absorber on a low frequency side. For electromagnetic emission on the side of the high frequency circuit board 32 is considered to be predominated by emission generated by electric current flowing around a solid ground plain on the circuit board. The emission is emitted from the peripheral portion of the high frequency circuit board 32. These phenomena are caused by the property of electrons, that are the origin of electromagnetic wave, to gather on the edge portion of a conductor. This is a well known phenomenon called edge effect.

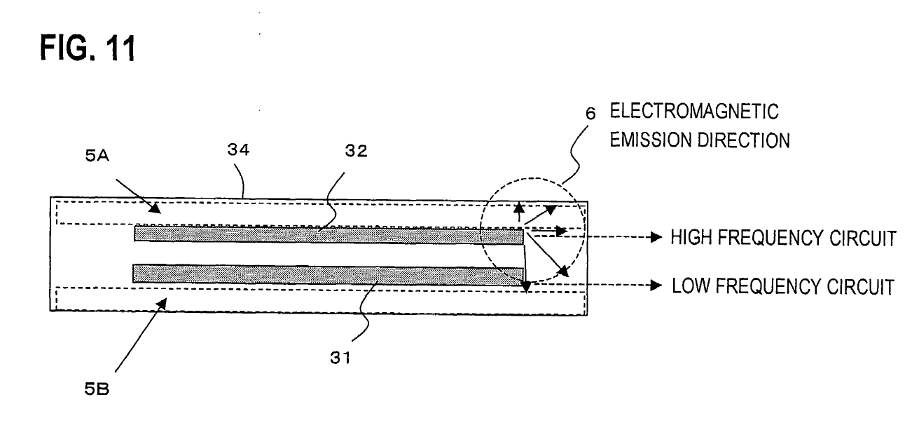

Thus in order to suppress electromagnetic wave emitted from an edge shown by a schematic cross-sectional view of FIG. 11, it may be preferable to dispose the radio wave absorber 5A and 5B in spaces between the hosing 34 and circuit boards 31, and 32, respectively. However, since adequate heat capacity cannot be obtained by the arrangement, wider coverage needs to be secured. Hence, arrangements taking the thermal conversion of radio wave emitted from edges, and spaces for releasing thermal energy into account are shown in FIGS. 8A and 9A. FIGS. 8B and 9B are to confirm if the intrusion of electromagnetic wave, that is emitted from the edges depicted in FIG. 11, to the side of the low frequency circuit board 31 needs to be considered or not.

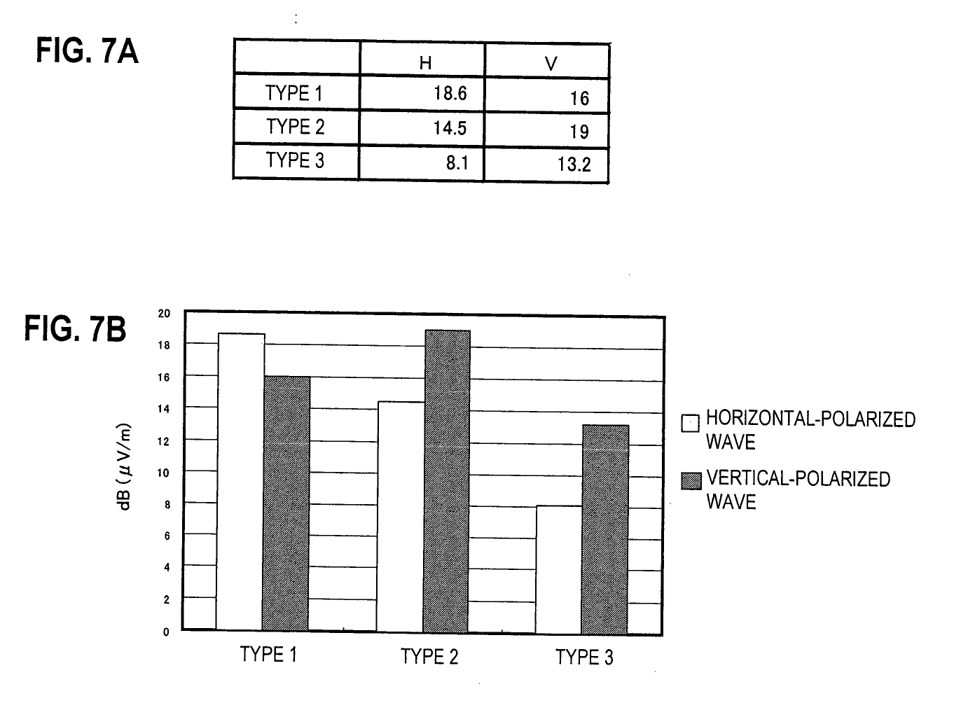

FIGS. 7A and 7B show data of experiments to verify the above exemplary configurations. In the measurement of EMI, it is necessary to confirm, by measuring both H- and V-polarized waves, that waves polarized in any direction do not act.

For example, a required criterion cannot be cleared in such a case that V-polarized wave is problematic while H-polarized wave is acceptable. The measurement result contains the variance of ca. 3 dB μV/m, thus a criterion including an allowance for the 9 dB μV/m for this case) needs to be satisfied. Hence a type 3 was rejected, and types 1 and 2 were acceptable, being verified with the above condition. Although it was indicated that the intrusion of electromagnetic wave to the side of the low frequency circuit board 31 was not significant for the both types, the type 1 is preferable taking polarization-independency into account.

In an application that was equipped with radio wave absorbers in the manner of FIGS. 8A and 8B as described above, improvement of more than or equal to ten μV/m could be attained as a result of an EMI measurement by one-meter method following VCCI (Voluntary Control Council for Information Technology Equipment) standard.

1. An optical transmitter/receiver module pluggable to a communication device, comprising:
a housing having openings on an anterior and a posterior ends;
an optical connector disposed at the anterior opening;
a photoelectric converting unit that converts a wavelength-division multiplexed optical signal, that is input from an optical transmission line connected to the optical connector, into an electric signal; and
a high frequency circuit board that performs high frequency signal processing of an electric signal converted by the photoelectric converting unit, wherein
at the posterior opening, a connecting terminal of the high frequency circuit board is formed so that it is pluggable to a mother board of a communication device, and wherein
radio wave absorbers are arranged in spaces between the top/bottom surfaces of the high frequency circuit board and the housing.

2. An optical transmitter/receiver module pluggable to a communication device, comprising:
a housing having openings on an anterior and a posterior ends;
a pair of optical connectors disposed at the anterior opening;
a photoelectric converting unit that converts a wavelength-division multiplexed optical signal, that is input from an optical transmission line to one of the pair of optical connectors, into an electric signal;
an electrical-optical converting unit that converts the electric signal into an optical signal that is to be output to the other of the pair of connectors and to be transmitted to the optical transmission line; and
a high frequency circuit board connected to the photoelectric and the electrical-optical converting units, the high frequency circuit board performing high frequency signal processing, wherein
at the posterior opening, a connecting terminal of the high frequency circuit board is formed so that it is pluggable to a mother board of a communication device, and wherein
radio wave absorbers are arranged in spaces between the top/bottom surfaces of the high frequency circuit board and the housing.

3. The optical transmitter/receiver module of claim 1, wherein:
the radio wave absorber is magnetic-permeable.

4. The optical transmitter/receiver module of claim 2, wherein:
the radio wave absorber is magnetic-permeable.
